(19) United States
(12) Patent Application Publication
(10) Pub. No.: US 2025/0103118 A1
(43) Pub. Date: Mar. 27, 2025

(54) COMMUNICATION SYSTEM, ELECTRONIC CONTROL DEVICE AND MANAGEMENT DEVICE

(71) Applicant: DENSO CORPORATION, Kariya-city (JP)

(72) Inventors: Ryota KAMEOKA, Kariya-city (JP); Tomohisa KISHIGAMI, Kariya-city (JP); Tomoya TOKUNAGA, Kariya-city (JP); Akira TADA, Kariya-city (JP)

(21) Appl. No.: 18/895,451

(22) Filed: Sep. 25, 2024

(30) Foreign Application Priority Data
Sep. 27, 2023 (JP) 2023-166035
Aug. 6, 2024 (JP) 2024-129826

(51) Int. Cl. G06F 1/26; G06F 1/28

(52) U.S. Cl. CPC G06F 1/263; G06F 1/28

(57) ABSTRACT

A communication system includes a plurality of electronic control devices connected to be capable of transmitting and receiving a communication frame. The electronic control devices includes a power supply switching device configured to receive a power supply from a power source via a power supply switching section and a management device connected to the electronic control devices to be capable of transmitting and receiving a communication frame, and is configured to control an operation of one or a plurality of power supply switching sections. At least one of the electronic control devices includes a frame generation section configured to generate a management frame that is a communication frame and a frame transmission section configured to transmit the management frame.

### CROSS REFERENCE TO RELATED APPLICATION

This application is based on Japanese Patent Application No. 2023-166035 filed on Sep. 27, 2023 and Japanese Patent Application No. 2024-129826 filed on Aug. 6, 2024, the disclosures of which are incorporated herein by reference.

### TECHNICAL FIELD

The present disclosure relates to a communication system including a plurality of electronic control devices.

### BACKGROUND

A related art discloses an in-vehicle network system that includes a power source relay for switching individually on and off a power source of each of a plurality of electronic control devices, determines a control content for switching the power source of a specific electronic control device between an on state and an off state in the specific electronic control device corresponding to a scene which is determined based on a situation of the vehicle, and switches the on state and the off state of the power source to supply an electric power to the specific electronic control device using the power source relay.

### SUMMARY

A communication system includes a plurality of electronic control devices connected to be capable of transmitting and receiving a communication frame. The electronic control devices includes a power supply switching device configured to receive a power supply from a power source via a power supply switching section and a management device connected to the electronic control devices to be capable of transmitting and receiving a communication frame, and is configured to control an operation of one or a plurality of power supply switching sections. At least one of the electronic control devices includes a frame generation section configured to generate a management frame that is a communication frame and a frame transmission section configured to transmit the management frame.

### BRIEF DESCRIPTION OF THE DRAWINGS

FIG. 1 is a block diagram showing a configuration of a communication system.

FIG. 2 is a diagram illustrating a configuration of a NM frame.

FIG. 3 is a flowchart of management processing.

FIG. 4 is a diagram showing the configuration of an activation table and a diagnosis mask table.

FIG. 5 is a block diagram illustrating the configuration of a communication system according to a second embodiment.

FIG. 6 is a diagram illustrating a correspondence relationship between a control target and a cluster.

FIG. 7 is a block diagram illustrating the configuration of a communication system according to a third embodiment.

FIG. 8 is a block diagram showing the configuration of a central ECU and an upstream electric power distribution section according to the third embodiment.

FIG. 9 is a first block diagram illustrating the configuration of a zone ECU according to the third embodiment.

FIG. 10 is a second block diagram illustrating the configuration of the zone ECU according to the third embodiment.

FIG. 11 is a block diagram illustrating a configuration of a slave ECU according to the third embodiment.

FIG. 12 is a flowchart illustrating a central management process.

### DETAILED DESCRIPTION

As a result of detailed studies by the inventors, the following difficulties have been found. In the in-vehicle network system described in a related art, all the electronic control devices connected to the management device are supplied with power from a power source via relays. Therefore, in the technology described in the related art, in a communication system in which an electronic control device connected to a relay and an electronic control device not connected to the relay are mixed, activation of a plurality of electronic control devices cannot be managed individually.

The present disclosure provides a technique to individually manage activation of a plurality of electronic control devices in a communication system including the plurality of electronic control devices.

According to one aspect of the present disclosure, a communication system including a plurality of electronic control devices connected to be capable of transmitting and receiving a communication frame is provided. The plurality of electronic control devices includes a power supply switching device and a management device. The power supply switching device is configured to receive a power supply from a power source via a power supply switching section configured to switch between a conduction state in which a power supply path is conducted and a cutoff state in which the power supply path is cut off. The management device is connected to the plurality of electronic control devices to be capable of transmitting and receiving a communication frame, and is configured to control an operation of one or a plurality of power supply switching sections. At least one of the plurality of electronic control devices includes a frame generation section and a frame transmission section. The frame generation section is configured to, when determining provision of a preset service based on a detected event, generate a management frame that is a communication frame including one or a plurality of pieces of switching information indicating whether to bring each of the one or the plurality of the power supply switching sections into the conduction state and one or a plurality of pieces of activation information indicating whether to activate an electronic control device that is not connected to the power supply switching section as a continuous power supply device for each of one or a plurality of the continuous power supply devices. The frame transmission section configured to transmit the management frame. The management device includes a power supply control section configured to bring each of the one or the plurality of the power supply switching sections into either the conduction state or the cutoff state based on the management frame.

In the communication system of the present disclosure configured as described above, the management device can bring one or the plurality of power supply switching sections into the conduction state or the cutoff state based on one or the plurality of pieces of switching information included in the management frame. Furthermore, in the communication system of the present disclosure, the management device can instruct one or a plurality of continuous power supply devices whether to activate based on one or a plurality of pieces of activation information included in the management frame. Therefore, in the communication system of the present disclosure, in a case where the electronic control device connected to the power supply switching section and the electronic control device not connected to the power supply switching section are mixed, the activation of the plurality of electronic control devices can be managed individually.

According to one aspect of the present disclosure, a communication system including a plurality of electronic control devices connected to be capable of transmitting and receiving a communication frame is provided.

The plurality of electronic control devices includes: a power supply switching device that receives a power supply from a power source via a power supply switching section configured to switch between a conduction state in which a power supply path is conducted and a cutoff state in which the power supply path is cut off, and a management device that is connected to the plurality of electronic control devices to be capable of transmitting and receiving a communication frame, and is configured to control an operation of one or a plurality of power supply switching sections. The management device includes a power supply control section configured to bring each of the one or the plurality of the power supply switching sections into either the conduction state or the cutoff state based on a management frame when receiving the management frame that is the communication frame including one or a plurality of pieces of switching information indicating whether to bring each of the one or the plurality of the power supply switching sections into the conduction state and one or a plurality of pieces of activation information indicating whether to activate an electronic control device that is not connected to the power supply switching section as a continuous power supply device for each of one or a plurality of continuous power supply devices.

In the communication system of the present disclosure configured as described above, the management device can bring one or the plurality of power supply switching sections into the conduction state or the cutoff state based on one or the plurality of pieces of switching information included in the management frame. Furthermore, in the communication system of the present disclosure, the management device can instruct one or a plurality of continuous power supply devices whether to activate based on one or a plurality of pieces of activation information included in the management frame. Therefore, in the communication system of the present disclosure, in a case where the electronic control device connected to the power supply switching section and the electronic control device not connected to the power supply switching section are mixed, the activation of the plurality of electronic control devices can be managed individually.

According to one aspect of the present disclosure, an electronic control device included in a communication system including one or a plurality of power supply switching sections configured to switch between a conduction state in which a power supply path is conducted from a power source to a power supply switching device and a cutoff state in which the power supply path is cut off is provided. The electronic control device includes: a frame generation section configured to, when determining a provision of a preset service based on a detected event, generate a management frame that is the communication frame including one or a plurality of pieces of switching information indicating whether to bring each of the one or the plurality of the power supply switching sections into the conduction state and one or a plurality of pieces of activation information indicating whether to activate one or a plurality of continuous power supply devices not connected to the power supply switching section, and a frame transmission section configured to transmit the management frame.

According to one aspect of the present disclosure, a management device connected to be capable of transmitting and receiving a communication frame with a plurality of electronic control devices and configured to control an operation of one or a plurality of power supply switching sections configured to switch between a conduction state in which a power supply path from a power supply to a power supply switching device is conducted and a cutoff state in which the power supply path is cut off is provided. The management device includes a power supply control section configured to receive a management frame that is the communication frame including one or a plurality of pieces of switching information indicating whether to bring each of the one or the plurality of the power supply switching sections into the conduction state and one or a plurality of pieces of activation information indicating whether to activate an electronic control device that is not connected to the power supply switching section as a continuous power supply device for each of one or a plurality of the continuous power supply devices, and to bring each of the one or the plurality of the power supply switching sections into either the conduction state or the cutoff state based on the management frame when receiving the management frame.

The management device of the present disclosure is a device used in the communication system of the present disclosure and can achieve the same effects as the communication system of the present disclosure.

Hereinafter, embodiments of the present disclosure will be described with reference to the drawings.

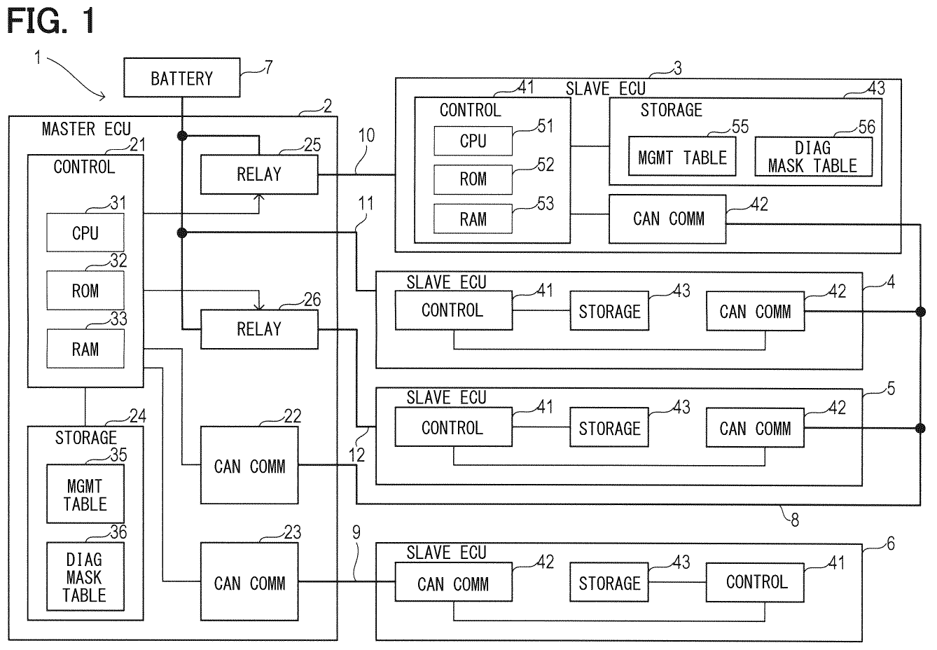

The communication system 1 of the present embodiment is mounted in a vehicle, and includes a master ECU 2, slave ECUs 3, 4, 5, and 6, and a battery 7, as shown in FIG. 1. The ECU is an abbreviation for an electronic control unit.

The master ECU 2 and the slave ECUs 3, 4, and 5 are connected to each other via a communication bus 8 so as to be capable of data communication. The master ECU 2 and the slave ECU 6 are connected to each other via a communication bus 9 so as to be capable of data communication.

The battery 7 supplies electric power to various parts of the vehicle at a DC (direct current) battery voltage (for example, 12V). The master ECU 2 and the slave ECUs 3 to 6 operate by receiving the electric power from the battery 7.

The master ECU 2 includes a control section 21, CAN communication units 22, 23, a storage section 24, and relays 25, 26. The CAN is an abbreviation for Controller Area Network. The communication protocol of the communication system 1 is not limited to CAN.

The control section 21 is an electronic control device mainly including a microcomputer with a CPU 31, a ROM 32, a RAM 33, and the like. Various functions of the microcomputer are implemented by the CPU 31 executing programs stored in a non-transitory tangible storage medium. In this example, the ROM 32 corresponds to the non-transitory tangible storage medium in which a program is stored. By executing the program, the method corresponding to the program is performed. A part or all of the functions to be executed by the CPU 31 may be configured in hardware by one or multiple ICs or the like. Alternatively, the number of the microcomputers constituting the control section 21 may be one or more.

The CAN communication section 22 communicates with the slave ECUs 3, 4, 5 connected to the communication bus 8 by transmitting and receiving a communication frame based on the CAN communication protocol. The CAN communication section 23 performs communication with the slave ECU 6 connected to the communication bus 9 by transmitting and receiving a communication frame based on the CAN communication protocol. Hereinafter, the CAN communication frame will be referred to as a CAN frame.

The storage section 24 is a storage device for storing various pieces of data. The storage section 24 stores a management table 35 and a diagnostic mask table 36 to be described later. The relay 25 is disposed on a power supply path 10 between the battery 7 and the slave ECU 3. The relay 26 is disposed on a power supply path 12 between the battery 7 and the slave ECU 5. The slave ECU 4 receives a power supply from the battery 7 via a power supply path 11.

The relay 25 is configured to switch between a conduction state in which the power supply path 10 is conducted and a cutoff state in which the power supply path 10 is cut off in accordance with a command from the control section 21. The relay 26 is configured to switch between a conduction state in which the power supply path 12 is conducted and a cutoff state in which the power supply path 12 is cut off in accordance with a command from the control section 21. Hereinafter, the conduction state is also referred to as an on state, and the cutoff state is also referred to as an off state.

The slave ECUs 3 to 6 include a control section 41, a CAN communication section 42, and a storage section 43. The control section 41 is an electronic control device mainly including a microcomputer comprising a CPU 51, a ROM 52, a RAM 53, and the like. Various functions of the microcomputer are implemented by the CPU 51 executing a program stored in a non-transitory tangible recording medium. In this example, the ROM 52 corresponds to a non-transitory tangible recording medium storing a program. Further, by executing this program, a method corresponding to the program is executed. Some or all of the functions executed by the CPU 51 may be configured as hardware by one or a plurality of ICs or the like. Furthermore, the number of microcomputers constituting the control section 41 may be one or more.

The CAN communication section 42 of the slave ECUs 3 to 5 performs communication with communication devices (i.e., the master ECU 2 and the slave ECUs 3 to 5) connected to the communication bus 8 based on the CAN communication protocol.

The CAN communication section 42 of the slave ECU 6 communicates with a communication device (that is, the master ECU 2) connected to the communication bus 9 based on a CAN communication protocol. The storage section 43 is a storage device for storing various pieces of data. The storage section 43 stores a management table 55 and a diagnostic mask table 56 to be described later.

The CAN frame includes a start of frame, an arbitration field, a control field, a data field, a CRC field, an ACK field, and an end of frame. The arbitration field includes an 11-bit or 29-bit identifier (i.e., ID) and a 1-bit RTR bit.

The 11-bit identifier used in CAN communication is referred to as a CAN ID. The CAN ID is preset based on the content of data included in the CAN frame, the transmission source of the CAN frame, the transmission destination of the CAN frame, and the like.

The data field is a payload including first data, second data, third data, fourth data, fifth data, sixth data, seventh data, and eighth data each of which has 8 bits (i.e., one byte).

The master ECU 2 and the slave ECUs 3, 4, 5, and 6 are configured to switch between a wake-up state (i.e., the activation state) and a sleep state (i.e., the dormancy state). The wake-up state is a normal operation state in which a function assigned to the ECU can be used without restriction. The sleep state is a low power consumption operation state in which available functions are restricted.

In the communication system 1, an NM frame, which is a CAN frame containing switching information and activation information, is used to switch the relays 25 and 26 to an on state or an off state and to switch the slave ECUs 4 and 6 not connected to the relays 25 and 26 to a wake-up state or a sleep state. NM is an abbreviation for Network Management.

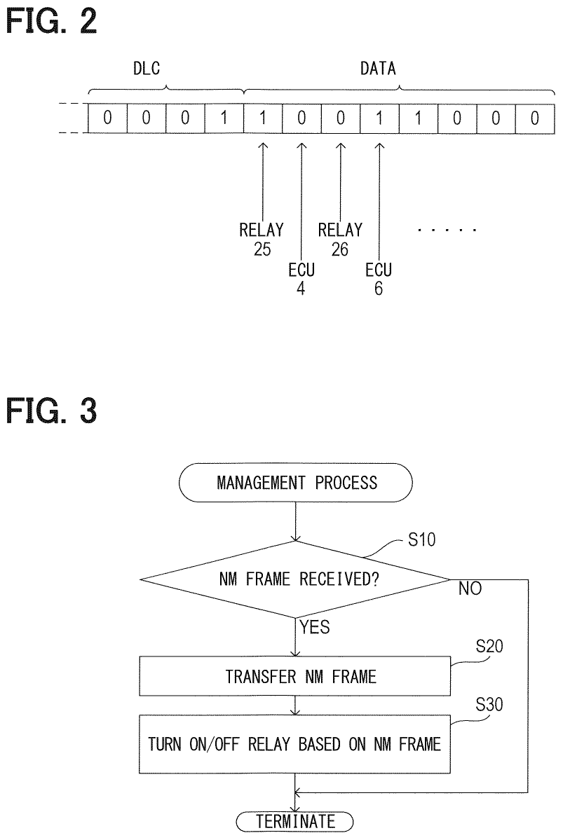

The switching information indicates whether to turn on the relays 25 and 26. The activation information indicates whether to bring the slave ECUs 4 and 6 into the wake-up state. The switching information and the activation information are set as illustrated in FIG. 2, for example. DLC stands for Data Length Code, and is a region representing the size of a data field in a CAN frame in byte units. That is, the switching information and the activation information are stored in the data field of the CAN frame. Here, in order to simplify the description, a case where DLC is 1 byte (that is, 8 bits) will be described.

The switching information of the relay 25, the switching information of the relay 26, the activation information of the slave ECU 4, and the activation information of the slave ECU 6 are allocated to respective bits of 8-bit data. In the NM frame illustrated in FIG. 2, the switching information of the relay 25 is allocated to the first highest bit of the first data, the activation information of the slave ECU 4 is allocated to the second highest bit of the first data, the switching information of the relay 26 is allocated to the third highest bit of the first data, and the activation information of the slave ECU 6 is allocated to the fourth highest bit of the first data.

Then, in the NM frame illustrated in FIG. 2, since 1 is set in the first highest bit of the first data, the NM frame illustrated in FIG. 2 instructs the relay 25 to be turned on.

In addition, in the NM frame illustrated in FIG. 2, since 0 is set in the second highest bit of the first data, the NM frame illustrated in FIG. 2 instructs the slave ECU 4 to be in the sleep state.

In addition, in the NM frame illustrated in FIG. 2, since 0 is set to the third highest bit of the first data, the NM frame illustrated in FIG. 2 instructs the relay 26 to be turned off. Further, in the NM frame illustrated in FIG. 2, since 1 is set to the fourth highest bit of the first data, the NM frame illustrated in FIG. 2 instructs the slave ECU 6 to be in the wake-up state.

The management tables 35 and 55 illustrated in FIG. 1 set a correspondence relationship between a service, and switching information and activation information for each of a plurality of services provided to an occupant of the vehicle using the master ECU 2 and the slave ECUs 3 to 6 as illustrated in FIG. 4. Note that the management tables 35 and 55 of the master ECU 2 and the slave ECUs 3 to 6 may not store switching information and activation information for a service for which the subject device cannot determine the establishment of the service start condition based on an event detected by the subject device.

The management tables 35 and 55 specify, for example, for the first service, that the relay 25 is turned on as the switching information of the relay 25, that the relay 26 is turned off as the switching information of the relay 26, that the slave ECU 4 is brought into a wake-up state as the activation information of the slave ECU 4, and that the slave ECU 6 is brought into a sleep state as the activation information of the slave ECU 6.

The management tables 35 and 55 specify, for example, for the second service, that the relay 25 is turned off as the switching information of the relay 25, that the relay 26 is turned on as the switching information of the relay 26, that the slave ECU 4 is brought into a sleep state as the activation information of the slave ECU 4, and that the slave ECU 6 is brought into a wake-up state as the activation information of the slave ECU 6.

By rewriting the management tables 35 and 55, it is possible to update the switching information and the activation information included in the NM frames transmitted by the master ECU 2 and the slave ECUs 3 to 6.

The management tables 35 and 55 may include activation information of the slave ECUs 3 and 5 that receive a power supply from the battery 7 via the relays 25 and 26. The diagnostic mask tables 36 and 56 illustrated in FIG. 1 set a correspondence relationship between a slave ECU (hereinafter, a cutoff ECU) whose power supply via a relay is cut off and a slave ECU (hereinafter, a sleep ECU) which is brought into a sleep state and a CAN ID (hereinafter, a non-reception frame ID) of a CAN frame which is not received, for each service as illustrated in FIG. 4.

Therefore, in the diagnostic mask tables 36 and 56, one or a plurality of combinations of the cutoff ECU and the non-reception frame ID, and one or a plurality of combinations of the sleep ECU and the non-reception frame ID are set for one service.

The diagnostic mask tables 36 and 56 specify, for example, for the first service, a combination of the slave ECU 5 and the first CAN ID and a combination of the slave ECU 6 and the second CAN ID.

The diagnostic mask tables 36 and 56 specify, for example, for the second service, a combination of the slave ECU 3 and the third CAN ID and a combination of the slave ECU 4 and the fourth CAN ID.

Therefore, when detecting that the start condition of the service is satisfied, the master ECU 2 and the slave ECUs 3 to 6 extract the switching information and the activation information corresponding to the corresponding service from the management tables 35 and 55, and generate and transmit the NM frame including the extracted switching information and activation information. Further, the master ECU 2 and the slave ECUs 3 to 6 extract a combination of the cutoff ECU or the sleep ECU corresponding to the corresponding service and the non-reception frame ID from the diagnostic mask tables 36 and 56 to transmit the extracted combination as diagnostic mask information.

In a state where a plurality of NM frames corresponding to a plurality of services are being transmitted, the relay is turned on by the OR (logical sum) of the switching information at the receiving ECU of the NM frame, and the relay is turned off by the AND (logical product) of the switching information. On the other hand, when the same ECU generates NM frames corresponding to a plurality of services, the ECU may generate and transmit a single NM frame corresponding to the plurality of services, using OR for the switching information to turn on the relay and AND for the switching information to turn off the relay.

As a result, even if the master ECU 2 and the slave ECUs 3 to 6 determine that communication with the cutoff ECU and the sleep ECU has been interrupted, it is possible to avoid regarding it as abnormal.

By rewriting the diagnostic mask tables 36 and 56, it is possible to update the diagnostic mask information transmitted by the master ECU 2 and the slave ECUs 3 to 6. Next, a procedure of a management process executed by the control section 21 of the master ECU 2 will be described. The management process is a process repeatedly executed during activation of the master ECU 2.

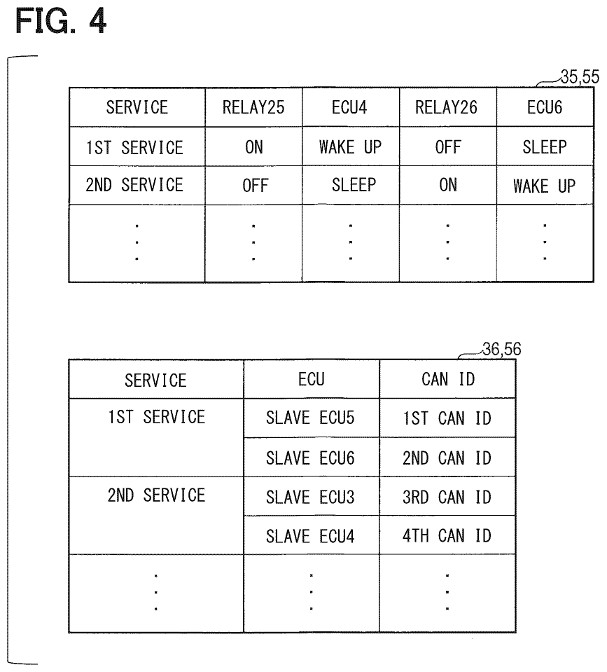

When the management process is executed, in S10, the CPU 31 of the control section 21 determines whether an NM frame has been received as illustrated in FIG. 3. Here, in a case where the NM frame has not been received, the CPU 31 terminates the management process. The master ECU 2 may generate and transmit the NM frame, and in this case, the operation is the same as when the NM frame is received.

On the other hand, in a case where the NM frame is received, in S20, the CPU 31 transfers the received NM frame. That is, the CPU 31 transmits the received

NM frame to a slave ECU other than the transmission source slave ECU. When receiving an NM frame from the master ECU 2, slave ECUs (that is, the slave ECUs 4 and 6) that are not connected to the relays 25 and 26 bring the subject device into a wake-up state or in a sleep state based on activation information included in the received NM frame and corresponding to the subject device. For example, in a case where the activation information included in the received NM frame and corresponding to the subject device is 1, the slave ECUs 4 and 6 bring the subject device into a wake-up state.

In S30, the CPU 31 brings the relays 25 and 26 into an on state or an off state based on the switching information included in the NM frame received in S10, and terminates the management process. For example, in a case where the switching information included in the NM frame received in S10 and corresponding to the relay 25 is 1, the CPU 31 brings the relay 25 into an on state.

The communication system 1 configured as described above includes the ECUs 2 to 6 connected so as to be capable of transmitting and receiving the CAN frame. The slave ECUs 3 and 5 receive a power supply from the battery 7 via relays 25 and 26 configured to switch between a conduction state in which the power supply paths 10 and 12 are conducted and a cutoff state in which the power supply paths 10 and 12 are cut off, respectively.

The master ECU 2 is connected to the slave ECUs 3 to 6 so as to be capable of transmitting and receiving a CAN frame, and is configured to control the operations of the relays 25 and 26. The master ECU 2 is configured to bring each of the relays 25 and 26 into either a conduction state or a cutoff state based on the NM frame when receiving the NM frame. The NM frame is a CAN frame including two pieces of switching information indicating whether to bring each of the relays 25 and 26 into a conduction state and two pieces of activation information indicating whether to activate each of the slave ECUs 4 and 6 not connected to the relays 25 and 26.

The master ECU 2 and the slave ECUs 3 to 6 are configured to generate and transmit an NM frame including the switching information and the activation information corresponding to the corresponding service when determining that the start condition of the service is satisfied.

In such a communication system 1, the master ECU 2 can bring the relays 25 and 26 into either the conduction state or the cutoff state based on the two pieces of switching information included in the NM frame. Further, in the communication system 1, the master ECU 2 can instruct the slave ECUs 4 and 6 whether to activate based on the two pieces of activation information included in the NM frame. Therefore, in a case where the ECU connected to the relay and the ECU not connected to the relay are mixed, the communication system 1 can individually manage the activation of the plurality of ECUs.

Upon receiving the NM frame, the master ECU 2 is configured to transfer the received NM frame to the slave ECUs 4 and 6. In the communication system 1, the master ECU 2 can instruct the slave ECUs 4 and 6 whether to activate by transferring the received NM frame. Therefore, the communication system 1 can simplify the processing of instructing whether to activate, and can reduce the processing load of the master ECU 2.

The master ECU 2 includes a management table 35, and each of the slave ECUs 3 to 6 includes the management table 55. The management tables 35 and 55 indicate a correspondence relationship between a service, and two pieces of switching information and two pieces of activation information for each of a plurality of preset services. Accordingly, the communication system 1 can update the switching information and the activation information included in the NM frame transmitted by the master ECU 2 and the slave ECUs 3 to 6 by rewriting the management tables 35 and 55.

In the embodiment described above, the ECUs 2 to 6 correspond to a plurality of electronic control devices. The relays 25 and 26 correspond to a power supply switching section. The battery 7 corresponds to a power source, the slave ECUs 3 and 5 correspond to a power supply switching device. The master ECU 2 corresponds to a management device.

The slave ECUs 4 and 6 correspond to a continuous power supply device. The NM frame corresponds to a management frame. S30 corresponds to the process as a power supply control section. S20 corresponds to the process as a transfer section.

The control sections 21 and 41 correspond to a frame generation section. The CAN communication sections 22, 23, and 42 correspond to a frame transmission section.

### Second Embodiment

Hereinafter, a second embodiment of the present disclosure will be described with reference to the drawings. The second embodiment will describe parts different from the first embodiment. The same reference numerals are given to the same configurations.

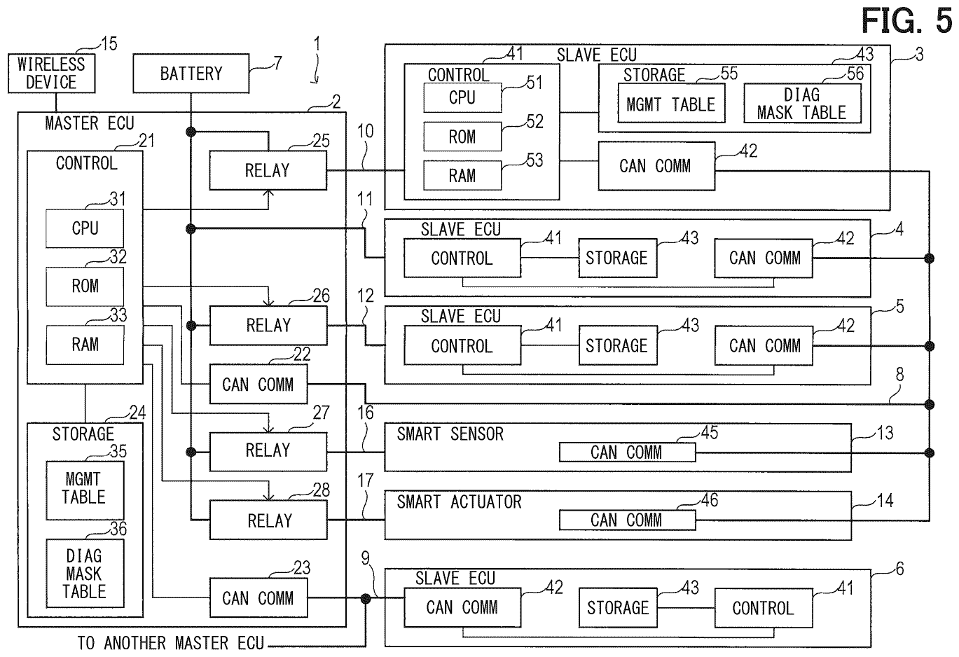

As illustrated in FIG. 5, the communication system 1 of the second embodiment differs from the first embodiment in that a smart sensor 13, a smart actuator 14, a wireless device 15, and relays 27 and 28 are added.

The smart sensor 13 is a sensor including a CAN communication section 45. The smart actuator 14 is an actuator including a CAN communication section 46. The CAN communication sections 45 and 46 perform communication by transmitting and receiving a communication frame based on the CAN communication protocol with a device connected to the communication bus 8.

The wireless device 15 is a wireless communication device for performing wireless communication with an external communication device installed outside the vehicle. The wireless device 15 is, for example, a DCM. DCM stands for Data Communication Module.

The relay 27 is disposed on a power supply path 16 between the battery 7 and the smart sensor 13. The relay 28 is disposed on a power supply path 17 between the battery 7 and the smart actuator 14.

The relays 27 and 28 are configured to switch between a conduction state in which the power supply paths 16 and 17 are conducted and a cutoff state in which the power supply paths 16 and 17 are cut off in accordance with a command from the control section 21.

Hereinafter, the master ECU 2, the slave ECUs 3 to 6, the smart sensor 13, and the smart actuator 14 are collectively referred to as nodes.

### (Prerequisite)

The master ECU 2, the slave ECU 4, and the slave ECU 6 are always supplied with power from the battery 7 without passing through a relay, and can switch between a wake-up state and a sleep state by themselves. Hereinafter, the master ECU 2, the slave ECU 4, and the slave ECU 6 are also referred to as NM-equipped nodes. An NM-equipped node is a node having a function of generating an NM frame.

The slave ECU 3, the slave ECU 5, the smart sensor 13, and the smart actuator 14 are powered via the relays and cannot switch to the wake-up state or sleep state independently. In other words, they enter the wake-up state when the relay is turned on and enter the sleep state when the relay is turned off. Hereinafter, the slave ECU 3, the slave ECU 5, the smart sensor 13, and the smart actuator 14 are also referred to as NM non-equipped nodes. The NM non-equipped node is a node that does not have the function to generate and interpret NM frames.

The NM non-equipped nodes include at least one of an actuator and a sensor, in addition to an ECU with control functions. The power supply paths of the NM non-equipped nodes are connected to the relays 25, 26, 27, and 28 of the master ECU 2, respectively.

The NM non-equipped nodes and the relays may be connected in a one-to-one manner, or multiple NM non-equipped nodes belonging to the same cluster (i.e., a group that activates simultaneously) may be connected under one relay.

The master ECU 2 and the NM-equipped nodes have CAN communication sections and can send and receive NM frames. The NM-equipped nodes determine whether they are in the wake-up state or sleep state based on the NM frames sent and received via the communication bus.

The master ECU 2 turns the relays 25, 26, 27, and 28, to which NM non-equipped nodes are connected, on or off based on the NM frames transmitted and received via the communication bus. The payload (i.e., data area) of the NM frames transmitted and received by the master ECU 2 and the NM-equipped nodes contains information indicating which cluster to activate, stored in one or more bits.

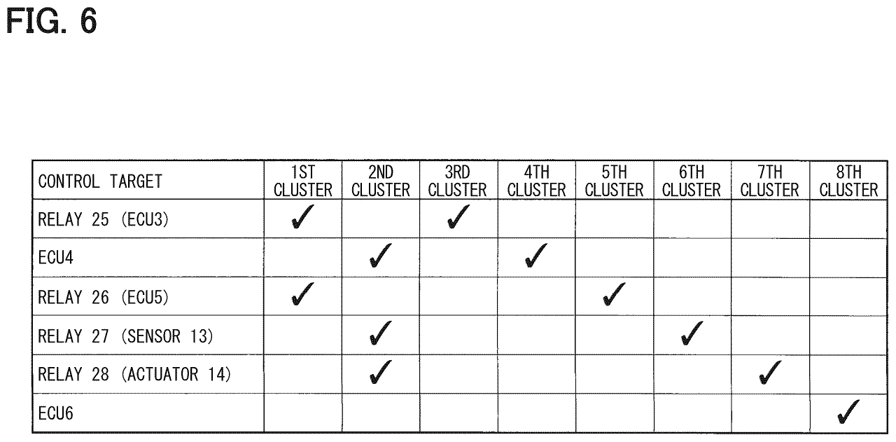

One or more master ECUs (i.e., ECUs with built-in relays) are installed in the vehicle. As shown in FIG. 6, one or more nodes belonging to each cluster are predetermined by a system developer. It is possible to assign clusters to each node, but multiple nodes can be registered in one cluster. When the bit corresponding to each cluster is active (i.e., bit=1), that cluster will wake up. In the case of the master ECU, waking up means turning the relay to the on state.

### First Activation Example

The first activation example is an operation example for performing fault diagnosis of the slave ECU 3 upon a request from the cloud.

First, a connection request comes from the base station (i.e., the cloud) to the vehicle's wireless device 15. Next, when the wireless device 15 determines that the connection is valid, the wireless device 15 informs the master ECU 2 of the event received from the cloud.

Next, the master ECU 2 determines the service as “fault diagnosis of the slave ECU 3” based on the event and generates an NM frame with the bit of the third cluster, to which only the slave ECU 3 belongs, set to active to activate the slave ECU 3.

Next, the master ECU 2 transmits the generated NM frame onto the communication buses 8 and 9. Since there are no NM-equipped nodes belonging to the third cluster on the communication buses 8 and 9, there is no change in the devices on the communication bus.

Next, the master ECU 2 simultaneously executes processing based on the NM frame in the control section 21 as if it had received the NM frame with the bit of the third cluster set to active. Then, the control section 21 of the master ECU 2 determines the wake-up instruction for the third cluster based on the NM frame, and since the relay 25 is included in the third cluster, the control section 21 turns the relay 25 to the on state.

When the relay 25 is turned on, power is supplied to the downstream slave ECU 3, which then activates. The master ECU 2 waits for the activation of the slave ECU 3, requests the diagnostic code from the slave ECU 3, and sends the response result from the slave ECU 3 to the base station via the wireless device 15.

### Second Activation Example

The second activation example is an operation example for performing fault diagnosis of the slave ECU 4 upon a request from the cloud.

First, a connection request comes from the base station (i.e., the cloud) to the vehicle's wireless device 15. Next, when the wireless device 15 determines that the connection is valid, the wireless device 15 informs the master ECU 2 of the event received from the cloud.

Next, the master ECU 2 determines the service as “fault diagnosis of the slave ECU 4” based on the event and generates an NM frame with the bit of the fourth cluster, to which only the slave ECU 4 belongs, set to active to activate the slave ECU 4.

Next, the master ECU 2 transmits the generated NM frame onto the communication buses 8 and 9. Since the slave ECU 4 is on the communication bus 8 as a node belonging to the fourth cluster, the slave ECU 4 wakes up.

Next, the master ECU 2 simultaneously executes processing based on the NM frame in the control section 21 as if the master ECU 2 had received the NM frame with the bit of the fourth cluster set to active. Then, even if the control section 21 of the master ECU 2 determines the wake-up instruction for the fourth cluster based on the NM frame, the control section 21 ignores it because there is no corresponding relay in the fourth cluster.

When the slave ECU 4 activates, the master ECU 2 requests the diagnostic code from the slave ECU 4 via the communication bus 8 and transmits the response result from the slave ECU 4 to the base station via the wireless device 15.

### Third Activation Example

The third activation example is an operation example where the user activates the remote air conditioning using a smartphone. First, the user instructs a vehicle air conditioner to turn on from the smartphone.

The wireless device 15 receives the instruction signal from the smartphone, and when the wireless device 15 determines that the instruction signal is valid, it informs the master ECU 2 of the event (i.e., instruction signal) received from the cloud.

The master ECU 2 determines the “air conditioning service” based on the event and generates an NM frame with the second cluster set to active as the air conditioning cluster. The master ECU 2 periodically transmits the generated NM frame onto the communication buses 8 and 9 until an air conditioner stop instruction is issued. When it is desired to continue the active state, it is necessary to continue transmitting the NM frame periodically. Simultaneously, the control section 21 of the master ECU 2 executes processing based on the NM frame.

When the NM frame with the second cluster set to active appears on the communication bus 8, the slave ECU 4 (i.e., air conditioner ECU) belonging to the second cluster receives the NM frame and wakes up according to the received NM frame.

When the control section 21 of the master ECU 2 detects that the second cluster is active, it turns the relays 27 and 28 belonging to the second cluster to the on state. When the relays 27 and 28 are turned on, power is supplied to the smart sensor 13 (i.e., a temperature sensor) and the smart actuator 14 (i.e., a compressor).

As a result, power supply to the air conditioner ECU, the smart sensor 13, and the smart actuator 14 begins, making it possible to turn on the vehicle air conditioner. When the user instructs the vehicle air conditioner to turn off from the smartphone, the master ECU 2 stops the periodic transmission of the NM frame.

When the NM frame is interrupted, the slave ECU 4 transitions to the sleep state, and the master ECU 2 turns off the relays 27 and 28. As a result, the vehicle air conditioner stops.

### Fourth Activation Example

The fourth activation example is an operation example where the vehicle air conditioner is activated from the slave ECU 4.

Since the slave ECU 4 is always supplied with power even when the vehicle is stopped, the slave ECU 4 can wake up by detecting the input of a signal indicating that the activation switch connected to the slave ECU 4 has been turned on, even while in sleep mode.

When the slave ECU 4 wakes up and confirms the input to be activated regarding the vehicle air conditioner, the slave ECU 4 generates an NM frame with the bit corresponding to the second cluster set to on. The slave ECU 4 transmits the generated NM frame via the CAN communication section 42. When the master ECU 2 receives this NM frame, the master ECU 2 turns the relays 27 and 28 belonging to the second cluster to the on state.

When the activation switch of the vehicle air conditioner is turned off, the slave ECU 4 stops transmitting the NM frame and transitions to the sleep state after a while. When the NM frame is interrupted, the master ECU 2 turns off the relays 27 and 28 after a while and ends the control.

If the master ECU 2 determines that it is necessary to continue control even after the NM frame transmission is stopped, the master ECU 2 transmits an NM frame with the bit corresponding to the second cluster set to on. As a result, the slave ECU 4 and the relays 27 and 28 can maintain the activation state until the transmission of the NM frame generated by the master ECU 2 is stopped.

### (Power Shutdown Process Extension)

The NM-equipped nodes are supplied with power without relays and can execute shutdown processes to transition to a low power state within the node. However, the NM non-equipped nodes cannot perform shutdown processes if the power supply is suddenly cut off by turning off the relay. Shutdown processes may include, for example, saving logs in operation, saving diagnostic data, saving learning results, and setting input/output devices to their initial positions for the next startup.

The communication system 1 of the second embodiment can implement the following first, second, third, and fourth measures to secure time for the shutdown process.

### (First Measure)

The master ECU 2, which controls the relays 25, 26, 27, and 28, notifies the subordinate nodes (i.e., the slave ECUs 3, 5, the smart sensor 13, and the smart actuator 14) of a relay-off pre-notification message via the CAN communication section 22 before executing the relay-off. Additionally, the master ECU 2 stops transmitting non-emergency CAN communications. The pre-notification message only needs to have a predetermined CAN ID and data pattern.

The master ECU 2 manages the time required for the shutdown process of the subordinate nodes (i.e., the slave ECUs 3, 5, the smart sensor 13, and the smart actuator 14). After sending the aforementioned pre-notification message, the master ECU 2 measures the elapsed time and turns off the relays 25, 26, 27, and 28 if the required shutdown time is exceeded. The NM non-equipped nodes stop communication, execute the shutdown process, and wait for the power supply to be cut off upon receiving the relay-off pre-notification message.

### (Second Measure)

The master ECU 2 notifies the subordinate nodes (i.e., the slave ECUs 3, 5, the smart sensor 13, and the smart actuator 14) of a relay-off pre-notification message via the CAN communication section 22 before executing the relay-off. Additionally, the master ECU 2 stops transmitting non-emergency CAN communications. The pre-notification message only needs to have a predetermined CAN ID and data pattern.

The master ECU 2 manages the time required for the shutdown process of each subordinate node (i.e., the slave ECUs 3, 5, the smart sensor 13, and the smart actuator 14) individually. After sending the aforementioned pre-notification message, the master ECU 2 measures the elapsed time and sequentially turns off the relays corresponding to the nodes if the required shutdown time is exceeded. The NM non-equipped nodes stop communication, execute the shutdown process, and wait for the power supply to be cut off upon receiving the relay-off pre-notification message.

### (Third Measure)

The master ECU 2 and the NM-equipped nodes synchronize sleep timing by mutually transmitting and receiving NM frames.

When the sleep condition is met upon the termination of the provided service, the master ECU 2 stops communication including the NM frames. Then, the master ECU 2 turns off the relays after the sum of the time for the NM non-equipped nodes to determine the absence of the NM frames (e.g., 3 seconds) and the time required for the shutdown process of the NM non-equipped nodes (e.g., 2 seconds) has elapsed (e.g., 5 seconds). The NM non-equipped nodes monitor the NM frames on the communication bus 8 and stop transmitting to the communication bus 8, execute the shutdown process, and wait for the power supply to be cut off if the absence of the NM frames is detected for a certain period (e.g., 3 seconds).

The NM non-equipped nodes can transmit a predetermined command to the master ECU 2 to request an extension of the time before the relay is turned off if they are unlikely to complete the shutdown process within the predetermined required time.

### (Fourth Measure)

The master ECU 2 and the NM-equipped nodes synchronize sleep timing by mutually transmitting and receiving the NM frames.

When the sleep condition of a predetermined cluster is met upon the termination of the provided service, the master ECU 2 sets the bits corresponding to the cluster in the NM frame to 0. After all bits become 0 and a certain period (e.g., 3 seconds) has elapsed, the master ECU 2 stops communication including the NM frames. Then, the master ECU 2 turns off the relays after the time required for the shutdown process of the NM non-equipped nodes (e.g., 2 seconds) has elapsed. Here, the NM non-equipped nodes have the function to receive and interpret the NM frames. The NM non-equipped nodes always monitor the NM frames transmitted by the master ECU 2 and start the shutdown process when all bits of the cluster including the upstream relay supplying power to the node are 0. This allows the NM non-equipped nodes to complete the shutdown process before the relay supplying power to the node is turned off. The NM-equipped nodes sleep according to the NM frames exchanged with the master ECU 2.

The NM non-equipped nodes can transmit a predetermined command to the master ECU 2 to request an extension of the time before the relay is turned off if they are unlikely to complete the shutdown process within the predetermined required time. In this case, the master ECU 2 waits to turn off the relay while receiving the extension request from the NM non-equipped nodes.

### Third Embodiment

The third embodiment of the present disclosure will be described below with reference to the drawings. The third embodiment will describe parts different from the first embodiment.

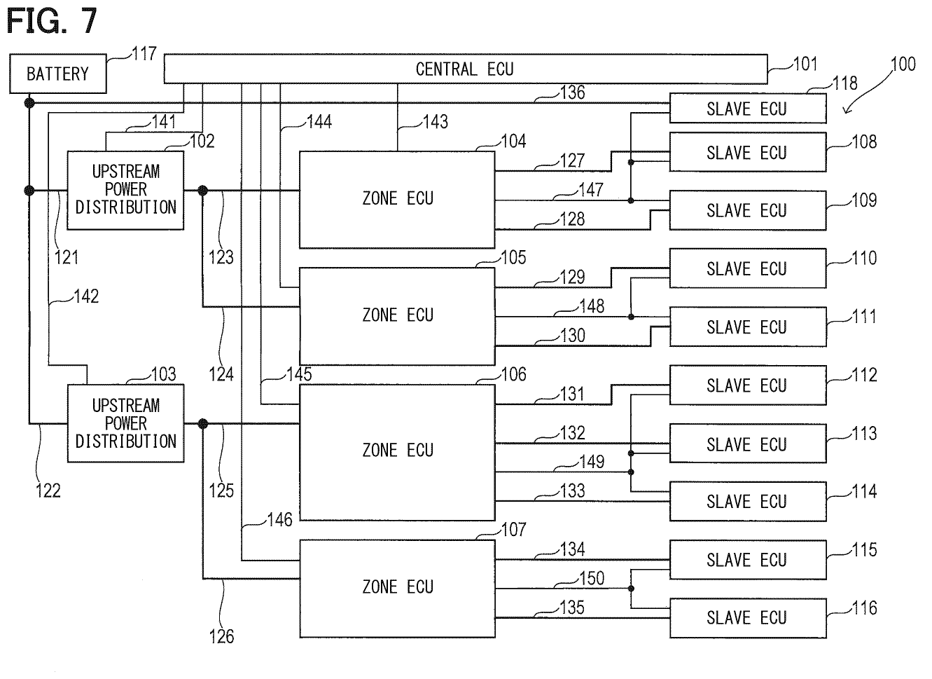

As illustrated in FIG. 7, the communication system 100 of the third embodiment includes a central ECU 101, upstream power distribution sections 102 and 103, zone ECUs 104, 105, 106, and 107, slave ECUs 108, 109, 110, 111, 112, 113, 114, 115, and 116, a battery 117, and a slave ECU 118. Hereinafter, the central ECU 101, the zone ECUs 104 to 107, and the slave ECUs 108 to 116 and 118 are collectively referred to as nodes.

The battery 117 supplies power to each section of the vehicle with a direct-current battery voltage (for example, 12 V). The central ECU 101, upstream power distribution sections 102 and 103, the zone ECUs 104 to 107, and the slave ECUs 108 to 116 and 118 operate by receiving a power supply from the battery 117.

The upstream power distribution section 102 receives a power supply from the battery 117 via a power supply path 121 between the battery 7 and the upstream power distribution section 102. The upstream power distribution section 103 receives a power supply from the battery 117 via a power supply path 122 between the battery 7 and the upstream power distribution section 103.

The zone ECUs 104 and 105 receive a power supply from the battery 117 via power supply paths 123 and 124 between the upstream power distribution section 102 and the zone ECUs 104 and 105, respectively.

The zone ECUs 106 and 107 receive a power supply from the battery 117 via power supply paths 125 and 126 between the upstream power distribution section 103 and the zone ECUs 106 and 107, respectively.

The slave ECUs 108 and 109 receive a power supply from the battery 117 via power supply paths 127 and 128 between the zone ECU 104 and the slave ECUs 108 and 109, respectively.

The slave ECUs 110 and 111 receive a power supply from the battery 117 via power supply paths 129 and 130 between the zone ECU 105 and the slave ECUs 110 and 111, respectively.

The slave ECUs 112, 113, and 114 receive a power supply from the battery 117 via power supply paths 131, 132, and 133 between the zone ECU 106 and the slave ECUs 112, 113, and 114, respectively.

The slave ECUs 115 and 116 receive a power supply from the battery 117 via power supply paths 134 and 135 between the zone ECU 107 and the slave ECUs 115 and 116, respectively.

The slave ECU 118 receives a power supply from the battery 117 via a power supply path 136. The central ECU 101 and the upstream power distribution section 102 are data-communicably connected to each other via a communication line 141.

The central ECU 101 and the upstream power distribution section 103 are data-communicably connected to each other via a communication line 142. The central ECU 101 and the zone ECUs 104, 105, 106, and 107 are data-communicably connected to each other via communication lines 143, 144, 145, and 146, respectively.

The zone ECU 104 and the slave ECUs 108, 109, and 118 are data-communicably connected to each other via a communication bus 147. The zone ECU 105 and the slave ECUs 110 and 111 are data-communicably connected to each other via a communication bus 148.

The zone ECU 106 and the slave ECUs 112, 113, and 114 are data-communicably connected to each other via a communication bus 149. The zone

ECU 107 and the slave ECUs 115 and 116 are data-communicably connected to each other via a communication bus 150.

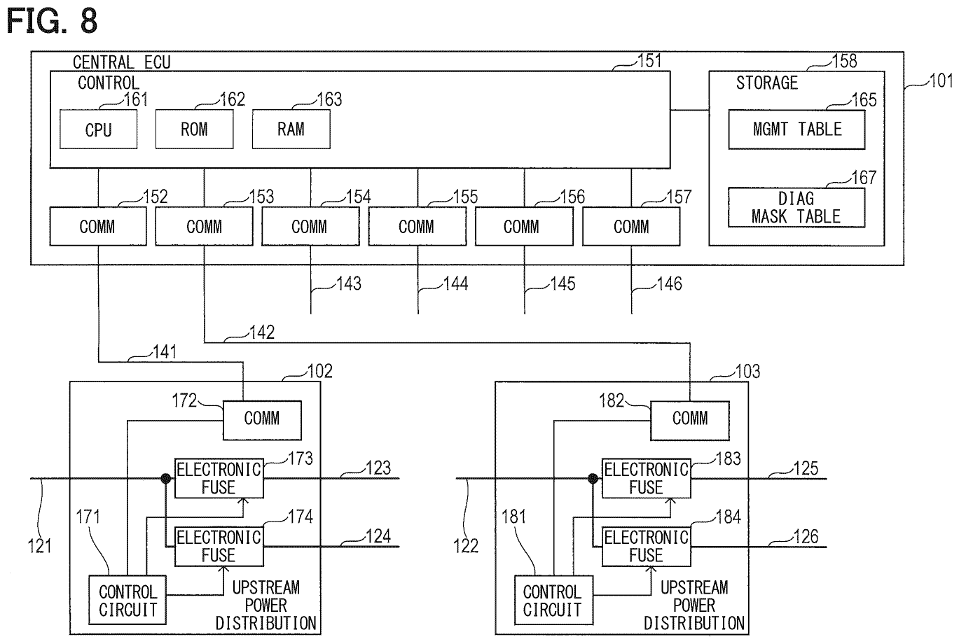

As illustrated in FIG. 8, the central ECU 101 includes a control section 151, communication sections 152, 153, 154, 155, 156, and 157, and a storage section 158. The control section 151 is an electronic control device mainly including a microcomputer including a CPU 161, a ROM 162, a RAM 163, and the like. Various functions of the microcomputer are implemented by the CPU 161 executing a program stored in a non-transitory tangible storage medium. In this example, the ROM 162 corresponds to a non-transitory tangible storage medium storing a program. Further, by executing this program, a method corresponding to the program is executed. Some or all of the functions executed by the CPU 161 may be configured as hardware by one or a plurality of ICs or the like. Furthermore, the number of microcomputers constituting the control section 151 may be one or more.

The communication section 152 performs communication with the upstream power distribution section 102 connected to the communication line 141 by transmitting and receiving a communication frame based on, for example, the Ethernet communication protocol. Ethernet is a registered trademark.

The communication section 153 performs communication with the upstream power distribution section 103 connected to the communication line 142 by transmitting and receiving a communication frame based on, for example, the Ethernet communication protocol. The communication section 154 performs communication with the zone ECU 104 connected to the communication line 143 by transmitting and receiving a communication frame based on, for example, the Ethernet communication protocol.

The communication section 155 performs communication with the zone ECU 105 connected to the communication line 144 by transmitting and receiving a communication frame based on, for example, the Ethernet communication protocol. The communication section 156 performs communication with the zone ECU 106 connected to the communication line 145 by transmitting and receiving a communication frame based on, for example, the Ethernet communication protocol.

The communication section 157 performs communication with the zone ECU 107 connected to the communication line 145 by transmitting and receiving a communication frame based on, for example, the Ethernet communication protocol. The storage section 158 is a storage device for storing various pieces of data. The storage section 158 stores a management table 165 and a diagnostic mask table 167 to be described later.

The upstream power distribution section 102 includes a control circuit 171, a communication section 172, and electronic fuses 173 and 174. The control circuit 171 controls switching of the electronic fuses 173 and 174 between an on state and an off state based on instructions obtained via the communication section 172 from the central ECU 101.

The communication section 172 performs communication with the central ECU 101 connected to the communication line 141 by transmitting and receiving a communication frame based on, for example, the Ethernet communication protocol.

The electronic fuse 173 is disposed between the power supply path 121 and the power supply path 123. The electronic fuse 174 is disposed between the power supply path 121 and the power supply path 124. The upstream power distribution section 103 includes a control circuit 181, a communication section 182, and electronic fuses 183 and 184.

The control circuit 181 controls switching of the electronic fuses 183 and 184 between an on state and an off state based on instructions obtained via the communication section 182 from the central ECU 101.

The communication section 182 performs communication with the central ECU 101 connected to the communication line 142 by transmitting and receiving a communication frame based on, for example, the Ethernet communication protocol.

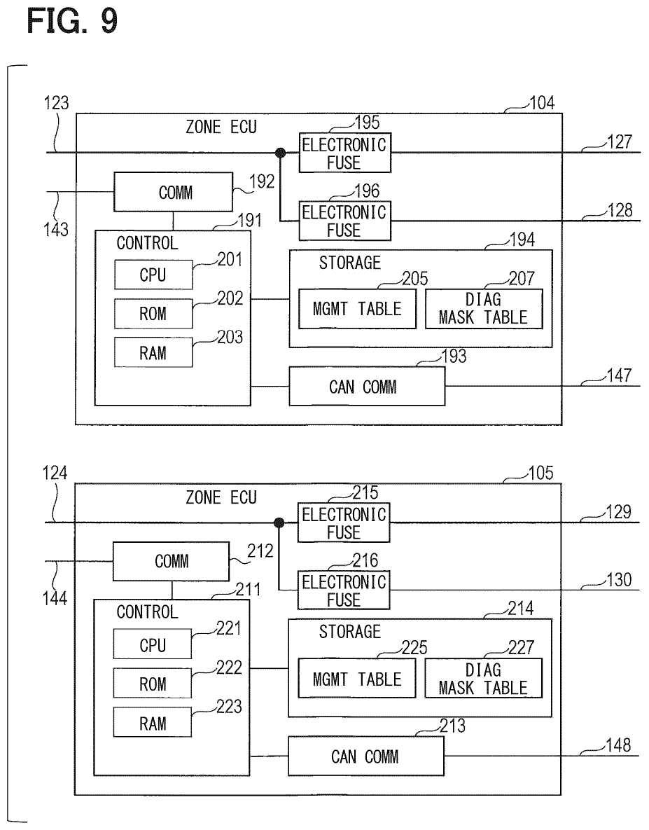

The electronic fuse 183 is disposed between the power supply path 122 and the power supply path 125. The electronic fuse 184 is disposed between the power supply path 122 and the power supply path 126. As illustrated in FIG. 9, the zone ECU 104 includes a control section 191, a communication section 192, a CAN communication section 193, a storage section 194, and electronic fuses 195 and 196.

The control section 191 is an electronic control device mainly including a microcomputer including a CPU 201, a ROM 202, a RAM 203, and the like. Various functions of the microcomputer are implemented by the CPU 201 executing a program stored in a non-transitory tangible storage medium. In this example, the ROM 202 corresponds to a non-transitory tangible storage medium storing a program. Further, by executing this program, a method corresponding to the program is executed. Some or all of the functions executed by the CPU 201 may be configured as hardware by one or a plurality of ICs or the like. Furthermore, the number of microcomputers constituting the control section 191 may be one or more.

The communication section 192 performs communication with the central ECU 101 connected to the communication line 143 by transmitting and receiving a communication frame based on, for example, the Ethernet communication protocol.

The CAN communication section 193 performs communication with the slave ECUs 108 and 109 connected to the communication bus 147 by transmitting and receiving a communication frame based on the CAN communication protocol.

The storage section 194 is a storage device for storing various pieces of data. The storage section 194 stores a management table 205 and a diagnostic mask table 207 to be described later. The electronic fuse 195 is disposed between the power supply path 123 and the power supply path 127. The electronic fuse 196 is disposed between the power supply path 123 and the power supply path 128.

The zone ECU 105 includes a control section 211, a communication section 212, a CAN communication section 213, a storage section 214, and electronic fuses 215 and 216. The control section 211 is an electronic control device mainly including a microcomputer including a CPU 221, a ROM 222, a RAM 223, and the like. Various functions of the microcomputer are implemented by the CPU 221 executing a program stored in a non-transitory tangible storage medium. In this example, the ROM 222 corresponds to a non-transitory tangible storage medium storing a program. Further, by executing this program, a method corresponding to the program is executed. Some or all of the functions executed by the CPU 221 may be configured as hardware by one or a plurality of ICs or the like. Furthermore, the number of microcomputers constituting the control section 211 may be one or more.

The communication section 212 performs communication with the central ECU 101 connected to the communication line 144 by transmitting and receiving a communication frame based on, for example, the Ethernet communication protocol.

The CAN communication section 213 performs communication with the slave ECUs 110 and 111 connected to the communication bus 148 by transmitting and receiving a communication frame based on the CAN communication protocol.

The storage section 214 is a storage device for storing various pieces of data. The storage section 214 stores a management table 225 and a diagnostic mask table 227 to be described later. The electronic fuse 215 is disposed between the power supply path 124 and the power supply path 129. The electronic fuse 216 is disposed between the power supply path 124 and the power supply path 130.

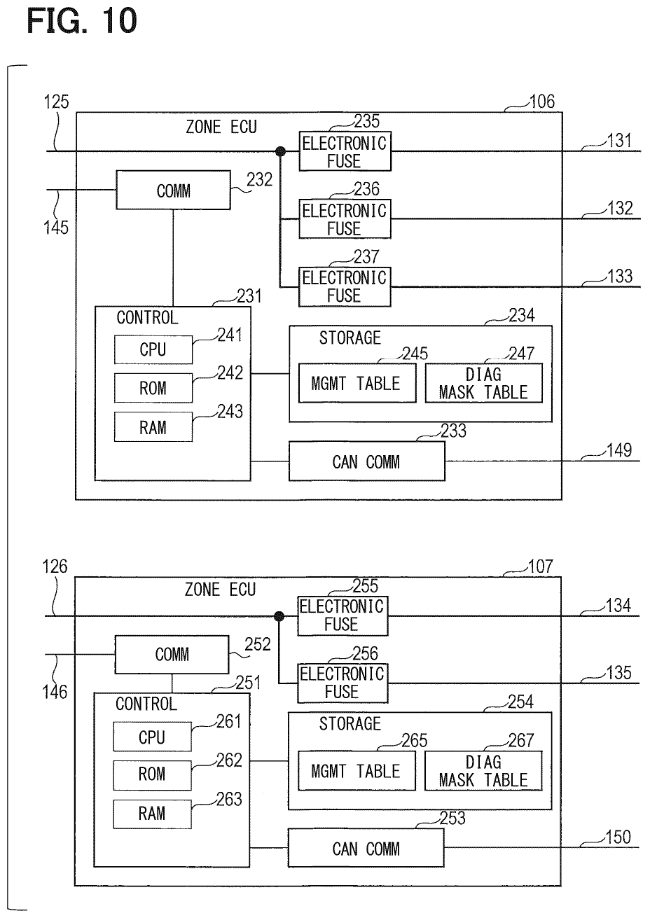

As illustrated in FIG. 10, the zone ECU 106 includes a control section 231, a communication section 232, a CAN communication section 233, a storage section 234, and electronic fuses 235, 236, and 237. The control section 231 is an electronic control device mainly including a microcomputer including a CPU 241, a ROM 242, a RAM 243, and the like. Various functions of the microcomputer are implemented by the CPU 241 executing a program stored in a non-transitory tangible storage medium. In this example, the ROM 242 corresponds to a non-transitory tangible storage medium storing a program. Further, by executing this program, a method corresponding to the program is executed. Some or all of the functions executed by the CPU 241 may be configured as hardware by one or a plurality of ICs or the like. Furthermore, the number of microcomputers constituting the control section 231 may be one or more.

The communication section 232 performs communication with the central ECU 101 connected to the communication line 145 by transmitting and receiving a communication frame based on, for example, the Ethernet communication protocol.

The CAN communication section 233 performs communication with the slave ECUs 112, 113, and 114 connected to the communication bus 149 by transmitting and receiving a communication frame based on the CAN communication protocol.

The storage section 234 is a storage device for storing various pieces of data. The storage section 194 stores a management table 245 and a diagnostic mask table 247 to be described later. The electronic fuse 235 is disposed between the power supply path 125 and the power supply path 131. The electronic fuse 236 is disposed between the power supply path 125 and the power supply path 132. The electronic fuse 237 is disposed between the power supply path 125 and the power supply path 133.

The zone ECU 107 includes a control section 251, a communication section 252, a CAN communication section 253, a storage section 254, and electronic fuses 255 and 256. The control section 251 is an electronic control device mainly including a microcomputer including a CPU 261, a ROM 262, a RAM 263, and the like. Various functions of the microcomputer are implemented by the CPU 261 executing a program stored in a non-transitory tangible storage medium. In this example, the ROM 262 corresponds to a non-transitory tangible storage medium storing a program. Further, by executing this program, a method corresponding to the program is executed. Some or all of the functions executed by the CPU 261 may be configured as hardware by one or a plurality of ICs or the like. Furthermore, the number of microcomputers constituting the control section 251 may be one or more.

The communication section 252 performs communication with the central ECU 101 connected to the communication line 146 by transmitting and receiving a communication frame based on, for example, the Ethernet communication protocol.

The CAN communication section 253 performs communication with the slave ECUs 115 and 116 connected to the communication bus 150 by transmitting and receiving communication frames based on the CAN communication protocol.

The storage section 254 is a storage device for storing various pieces of data. The storage section 254 stores a management table 265 and a diagnostic mask table 267 to be described later. The electronic fuse 255 is disposed between the power supply path 126 and the power supply path 134. The electronic fuse 256 is disposed between the power supply path 126 and the power supply path 135.

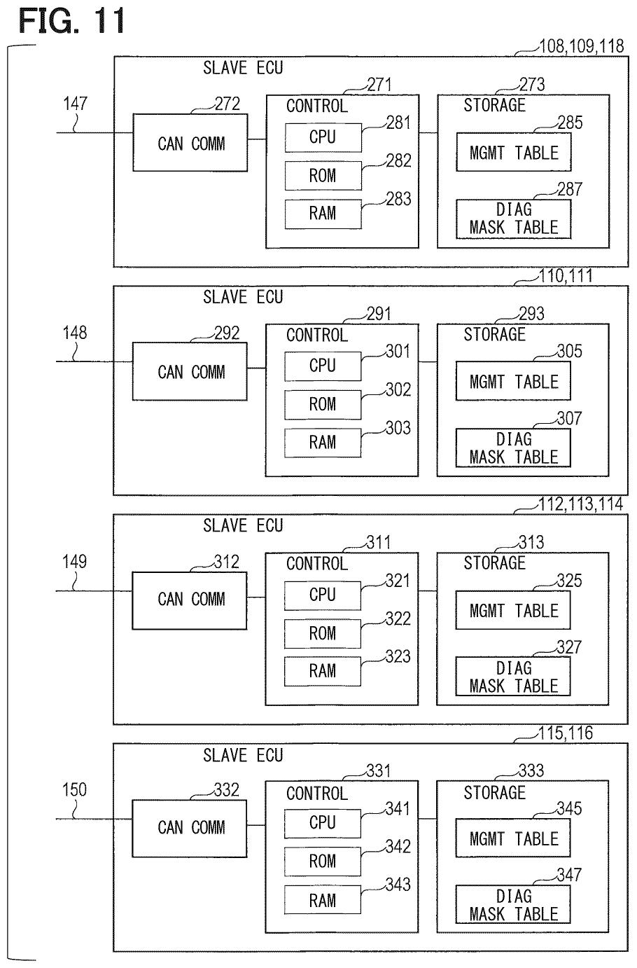

As illustrated in FIG. 11, the slave ECUs 108, 109, and 118 include a control section 271, a CAN communication section 272, and a storage section 273. The control section 271 is an electronic control device mainly including a microcomputer including a CPU 281, a ROM 282, a RAM 283, and the like. Various functions of the microcomputer are implemented by the CPU 281 executing a program stored in a non-transitory tangible storage medium. In this example, the ROM 282 corresponds to a non-transitory tangible storage medium storing a program. Further, by executing this program, a method corresponding to the program is executed. Some or all of the functions executed by the CPU 281 may be configured as hardware by one or a plurality of ICs or the like. Furthermore, the number of microcomputers constituting the control section 271 may be one or more.

The CAN communication section 272 performs communication with the zone ECU 104 connected to the communication bus 147 by transmitting and receiving communication frames based on the CAN communication protocol. The storage section 273 is a storage device for storing various pieces of data. The storage section 273 stores a management table 285 and a diagnostic mask table 287 to be described later.

The slave ECUs 110 and 111 include a control section 291, a CAN communication section 292, and a storage section 293. The control section 291 is an electronic control device mainly including a microcomputer including a CPU 301, a ROM 302, a RAM 303, and the like. Various functions of the microcomputer are implemented by the CPU 301 executing a program stored in a non-transitory tangible storage medium. In this example, the ROM 302 corresponds to a non-transitory tangible storage medium storing a program. Further, by executing this program, a method corresponding to the program is executed. Some or all of the functions executed by the CPU 301 may be configured as hardware by one or a plurality of ICs or the like. Furthermore, the number of microcomputers constituting the control section 291 may be one or more.

The CAN communication section 292 performs communication with the zone ECU 105 connected to the communication bus 148 by transmitting and receiving communication frames based on the CAN communication protocol. The storage section 293 is a storage device for storing various pieces of data. The storage section 293 stores a management table 305 and a diagnostic mask table 307 to be described later.

The slave ECUs 112, 113, and 114 include a control section 311, a CAN communication section 312, and a storage section 313. The control section 311 is an electronic control device mainly including a microcomputer including a CPU 321, a ROM 322, a RAM 323, and the like. Various functions of the microcomputer are implemented by the CPU 321 executing a program stored in a non-transitory tangible storage medium. In this example, the ROM 322 corresponds to a non-transitory tangible storage medium storing a program. Further, by executing this program, a method corresponding to the program is executed. Some or all of the functions executed by the CPU 321 may be configured as hardware by one or a plurality of ICs or the like. Furthermore, the number of microcomputers constituting the control section 311 may be one or more.

The CAN communication section 312 performs communication with the zone ECU 106 connected to the communication bus 149 by transmitting and receiving communication frames based on the CAN communication protocol. The storage section 313 is a storage device for storing various pieces of data. The storage section 313 stores a management table 325 and a diagnostic mask table 327 to be described later.

The slave ECUs 115 and 116 include a control section 331, a CAN communication section 332, and a storage section 333. The control section 331 is an electronic control device mainly including a microcomputer including a CPU 341, a ROM 342, a RAM 343, and the like. Various functions of the microcomputer are implemented by the CPU 341 executing a program stored in a non-transitory tangible recording medium. In this example, the ROM 342 corresponds to a non-transitory tangible recording medium storing a program. Further, by executing this program, a method corresponding to the program is executed. Some or all of the functions executed by the CPU 341 may be configured as hardware by one or a plurality of ICs or the like. Furthermore, the number of microcomputers constituting the control section 331 may be one or more.

The CAN communication section 332 performs communication with the zone ECU 107 connected to the communication bus 150 by transmitting and receiving communication frames based on the CAN communication protocol. The storage section 333 is a storage device for storing various pieces of data. The storage section 333 stores a management table 345 and a diagnostic mask table 347 to be described later.

The management tables 165, 205, 225, 245, 265, 285, 305, 325, and 345 set a correspondence relationship between a service, and switching information and activation information for each of a plurality of services provided to an occupant of a vehicle using the central ECU 101, the zone ECUs 104 to 107, and the slave ECUs 108 to 116 and 118.

Therefore, in the management tables 165, 205, 225, 245, 265, 285, 305, 325, and 345, switching information is set for the electronic fuses 173, 174, 183, 184, 195, 196, 215, 216, 235, 236, 237, 255, and 256, and activation information is set for the central ECU 101 and the slave ECU 118.

The management tables 165, 205, 225, 245, 265, 285, 305, 325, and 345 may not store switching information and activation information for services that the subject device cannot detect the establishment of the service start condition.

The diagnostic mask tables 167, 207, 227, 247, 267, 287, 307, 327, and 347 set a correspondence relationship between a slave ECU (hereinafter, cutoff ECU) whose power supply via an electronic fuse is cut off and a CAN ID (hereinafter, non-reception frame ID) of a CAN frame which is not received, and a slave ECU (hereinafter, sleep ECU) which is brought into a sleep state and the CAN ID, for each service.

Therefore, when detecting that the start condition of the service is satisfied based on the detected event, the central ECU 101, zone ECUs 104 to 107, and slave ECUs 108 to 116 and 118 extract the switching information and activation information corresponding to the corresponding service from the management tables 165, 205, 225, 245, 265, 285, 305, 325, and 345, generate and transmit the NM frame including the extracted switching information and activation information. Further, the central ECU 101, zone ECUs 104 to 107, and slave ECUs 108 to 116 and 118 extract a combination of the cutoff ECU or the sleep ECU corresponding to the corresponding service and the non-reception frame ID from the diagnostic mask tables 167, 207, 227, 247, 267, 287, 307, 327, and 347 to transmit the extracted combination as diagnostic mask information.

Next, a procedure of a central management process executed by the control section 151 of the central ECU 101 will be described. The central management process is a process repeatedly executed during activation of the central ECU 101.

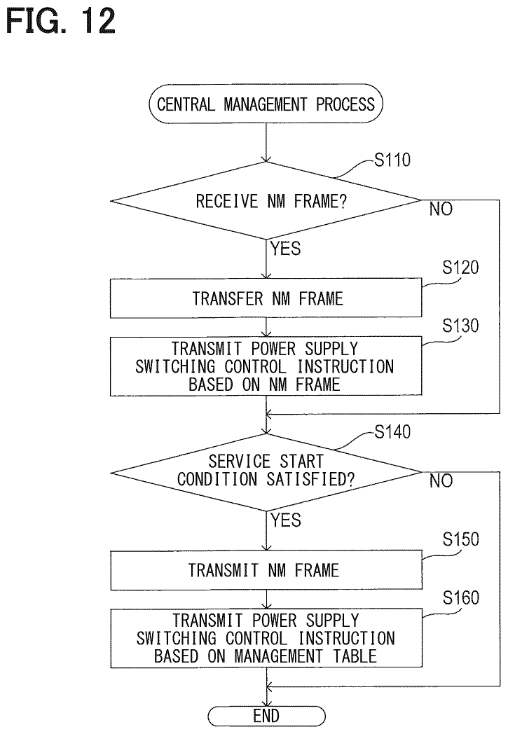

When the central management process is executed, in S110, the CPU 161 of the control section 151 determines whether an NM frame has been received as illustrated in FIG. 12. Here, in a case where the NM frame has not been received, the CPU 161 proceeds to S140.

On the other hand, in a case where the NM frame is received, in S120, the CPU 161 transfers the received NM frame to the zone ECUs 104 to 107. The zone ECUs 104 to 107 that have received the NM frame from the central ECU 101 transfer the NM frame to the subordinate slave ECUs. Further, the zone ECUs 104 to 107 that have received the NM frame from the central ECU 101 turn on or off the built-in electronic fuses based on the switching information included in the received NM frame.

In S130, the CPU 161 sends a power supply switching control instruction to the upstream power distribution sections 102 and 103 to turn on or off the electronic fuses 173, 174, 183, and 184 of the upstream power distribution sections 102 and 103 based on the switching information included in the NM frame received in S110, and then proceeds to S140.

In S140, the CPU 161 determines whether a service start condition preset for the central ECU 101 has been satisfied. Here, in a case where the service start condition is not satisfied, the CPU 161 terminates the central management process.

On the other hand, in a case where the service start condition is satisfied, in S150, the CPU 161 extracts the switching information and activation information corresponding to the service satisfied in S140 from the management table 165, generates the NM frame including the extracted switching information and activation information, and transmits it to the zone ECUs 104 to 107.

In S160, the CPU 161 transmits a power supply switching control instruction to the upstream power distribution sections 102 and 103 to turn on or off the electronic fuses 173, 174, 183, and 184 of the upstream power distribution sections 102 and 103 based on the switching information corresponding to the service satisfied in S140 by referring to the management table 165, and then terminates the central management process.

The communication system 100 configured as described above includes the ECUs 101 and 104 to 116 and 118 connected so as to be capable of transmitting and receiving communication frames. The slave ECUs 108 and 109 receive a power supply from the battery 117 via the electronic fuses 195 and 196 configured to switch between a conduction state in which the power supply paths 127 and 128 are conducted and a cutoff state in which the power supply paths 127 and 128 are cut off, respectively.

The central ECU 101 is connected to the zone ECU 104 and the slave ECUs 108 and 109 so as to be capable of transmitting and receiving communication frames, and is configured to control the operations of the electronic fuses 195 and 196.

The ECUs 101 and 104 to 116 and 118 are configured to determine the provision of a preset service based on the detected event and generate an NM frame according to the service. The NM frame is a communication frame including switching information indicating whether to bring each of the electronic fuses 195, 196, 215, 216, 235, 236, 237, 255, and 256 into a conduction state and activation information indicating whether to activate the slave ECU 118 not connected to the electronic fuses.

The ECUs 101 and 104 to 116 and 118 are configured to transmit the generated management frame. The central ECU 101 is configured to bring each of the electronic fuses 195 and 196 into either a conduction state or a cutoff state based on the NM frame.

In such a communication system 100, the central ECU 101 can bring the electronic fuses 195 and 196 into either the conduction state or the cutoff state based on the two pieces of switching information included in the NM frame. Further, in the communication system 100, the central ECU 101 can instruct the slave ECU 118 whether to activate based on the one piece of activation information included in the NM frame. Therefore, in a case where the ECU connected to the electronic fuse and the ECU not connected to the electronic fuse are mixed, the communication system 100 can individually manage the activation of the plurality of ECUs.

In the embodiment described above, the ECUs 101 and 104 to 116 and 118 correspond to a plurality of electronic control devices, the electronic fuses 195 and 196 correspond to a power supply switching section, the battery 117 corresponds to a power source, the slave ECUs 108 and 109 correspond to a power supply switching device, and the central ECU 101 corresponds to a management device.

The slave ECU 118 corresponds to a continuous power supply device, the NM frame corresponds to a management frame, S130 corresponds to the process as a power supply control section. Further, the control sections 151, 191, 211, 231, 251, 271, 291, 311, and 331 correspond to a frame generation section, and the communication sections 154 to 157, 192, 212, 232, 252, and the CAN communication sections 193, 213, 233, 253, 272, 292, 312, and 332 correspond to a frame transmission section.

Although one embodiment of the present disclosure has been described above, the present disclosure is not limited to the above embodiment and can be implemented in various modifications. The control sections 21 and 41 and their methods described in the present disclosure may be implemented by a dedicated computer provided by configuring a processor and memory programmed to execute one or more functions embodied by a computer program. Alternatively, the control sections 21 and 41 and their methods described in the present disclosure may be implemented by a dedicated computer provided by configuring a processor with one or more dedicated hardware logic circuits. Alternatively, the control sections 21 and 41 and their methods described in the present disclosure may be implemented by one or more dedicated computers configured by a combination of a processor and memory programmed to execute one or more functions and one or more hardware logic circuits. The computer program may be stored in a computer-readable non-transitory tangible recording medium as instructions executed by a computer. The method for realizing the functions of each section included in the control sections 21 and 41 does not necessarily need to include software, and all the functions may be realized using one or more hardware.

The multiple functions possessed by one component in the above embodiment may be realized by multiple components, or one function possessed by one component may be realized by multiple components. Further, multiple functions possessed by multiple components may be realized by one component, or one function realized by multiple components may be realized by one component. Further, part of the configuration of the above embodiment may be omitted. Further, at least part of the configuration of the above embodiment may be added to or replaced with the configuration of another embodiment.

In addition to the ECUs 2 to 6, 101, and 104 to 116 and 118 described above, the present disclosure can also be realized in various forms such as a system including the ECUs 2 to 6, 101, and 104 to 116 and 118 as components, a program for causing a computer to function as the ECUs 2 to 6, 101, and 104 to 116 and 118, a non-transitory tangible recording medium such as a semiconductor memory recording the program, and a communication management method.

What is claimed is:

1. A communication system comprising
a plurality of electronic control devices connected to be capable of transmitting and receiving a communication frame,
wherein
the plurality of electronic control devices includes:
a power supply switching device configured to receive a power supply from a power source via a power supply switching section configured to switch between a conduction state in which a power supply path is conducted and a cutoff state in which the power supply path is cut off, and
a management device that is connected to the plurality of electronic control devices to be capable of transmitting and receiving a communication frame, and is configured to control an operation of one or a plurality of power supply switching sections, and
at least one of the plurality of electronic control devices includes
a frame generation section configured to, when determining provision of a preset service based on a detected event, generate a management frame that is a communication frame including one or a plurality of pieces of switching information indicating whether to bring each of the one or the plurality of the power supply switching sections into the conduction state and one or a plurality of pieces of activation information indicating whether to activate an electronic control device that is not connected to the power supply switching section as a continuous power supply device for each of one or a plurality of continuous power supply devices, and
a frame transmission section configured to transmit the management frame, and
the management device includes a power supply control section configured to bring each of the one or the plurality of the power supply switching sections into either the conduction state or the cutoff state based on the management frame.

2. A communication system comprising
a plurality of electronic control devices connected to be capable of transmitting and receiving a communication frame,
wherein
the plurality of electronic control devices includes:
a power supply switching device that receives a power supply from a power source via a power supply switching section configured to switch between a conduction state in which a power supply path is conducted and a cutoff state in which the power supply path is cut off, and
a management device that is connected to the plurality of electronic control devices to be capable of transmitting and receiving a communication frame, and is configured to control an operation of one or a plurality of power supply switching sections, and
the management device includes a power supply control section configured to bring each of the one or the plurality of the power supply switching sections into either the conduction state or the cutoff state based on a management frame when receiving the management frame that is the communication frame including one or a plurality of pieces of switching information indicating whether to bring each of the one or the plurality of the power supply switching sections into the conduction state and one or a plurality of pieces of activation information indicating whether to activate an electronic control device that is not connected to the power supply switching section as a continuous power supply device for each of one or a plurality of continuous power supply devices.

3. The communication system according to claim 2, wherein
the management device further includes a transfer section configured to transfer the received management frame to one or a plurality of the continuous power supply devices when receiving the management frame.

4. The communication system according to claim 2, wherein
each of the plurality of electronic control devices further includes a management table indicating, for each of a plurality of preset services, a correspondence relationship between a service, and the one or the plurality of pieces of switching information and the one or the plurality of pieces of activation information.

5. The communication system according to claim 2, wherein
the management frame includes information indicating whether to activate the power supply switching device that receives a power supply from the power source via the power supply switching section.

6. The communication system according to claim 2, wherein
the continuous power supply device is configured to switch between a wake-up state and a sleep state based on the activation information included in the management frame.

7. The communication system according to claim 2, wherein
the management device is configured to transfer the received management frame to the power supply switching device.

8. The communication system according to claim 2, wherein
the management device is configured to transmit a pre-notification message to the power supply switching device connected to the power supply switching section to notify that the power supply switching section will be brought into the cutoff state before bringing the power supply switching section into the cutoff state, and to bring the power supply switching section into the cutoff state after a preset shutdown process required time for the power supply switching device to execute the shutdown process has elapsed after sending the pre-notification message.

9. The communication system according to claim 8, wherein
the shutdown process required time is individually set for each of one or a plurality of power supply switching devices connected to the power supply switching section.

10. The communication system according to claim 2, wherein
the management device is configured to stop transmitting the management frame when a preset sleep condition for switching the management device to a sleep state is satisfied, and to bring the power supply switching section into the cutoff state after sum of a time for the power supply switching device to determine absence of the management frame and a time required for a shutdown process of the power supply switching device has elapsed.

11. The communication system according to claim 2, wherein
the management device is configured to set all bits of the switching information and the activation information included in the management frame from 1 to 0 when a preset sleep condition for switching the management device to a sleep state is satisfied, and to bring the power supply switching section into the cutoff state after a certain period has elapsed after all bits of the switching information and the activation information have become 0.

12. An electronic control device included in a communication system including one or a plurality of power supply switching sections configured to switch between a conduction state in which a power supply path is conducted from a power source to a power supply switching device and a cutoff state in which the power supply path is cut off, the electronic control device comprising:
a frame generation section configured to, when determining a provision of a preset service based on a detected event, generate a management frame that is a communication frame including one or a plurality of pieces of switching information indicating whether to bring each of the one or the plurality of the power supply switching sections into the conduction state and one or a plurality of pieces of activation information indicating whether to activate one or a plurality of continuous power supply devices not connected to the power supply switching section, and
a frame transmission section configured to transmit the management frame.

13. The electronic control device according to claim 12, wherein
the electronic control device is configured to stop transmitting the management frame when a sleep condition for transitioning to a sleep state is satisfied upon termination of the service.

14. The electronic control device according to claim 12, wherein
a plurality of electronic control devices includes:
the power supply switching device, as a slave control device that receives the power supply from the power source via the power supply switching section;
a zone control device that is connected to the slave control device to be capable of transmitting and receiving the communication frame and is configured to control an operation of the power supply switching section; and
a central control device that is connected to the zone control device to be capable of transmitting and receiving the communication frame, and
the electronic control device is the central control device, and
the central control device is configured to generate and transmit the management frame when determining provision of the service.

15. A management device connected to be capable of transmitting and receiving a communication frame with a plurality of electronic control devices and configured to control an operation of one or a plurality of power supply switching sections configured to switch between a conduction state in which a power supply path from a power supply to a power supply switching device is conducted and a cutoff state in which the power supply path is cut off, the management device comprising
a power supply control section configured to receive a management frame that is the communication frame including one or a plurality of pieces of switching information indicating whether to bring each of the one or the plurality of the power supply switching sections into the conduction state and one or a plurality of pieces of activation information indicating whether to activate an electronic control device that is not connected to the power supply switching section as a continuous power supply device for each of one or a plurality of continuous power supply devices, and to bring each of the one or the plurality of the power supply switching sections into either the conduction state or the cutoff state based on the management frame when receiving the management frame.

16. The communication system according to claim 2, wherein
the plurality of electronic control devices includes:
the power supply switching device, as a slave control device that receives a power supply from the power source via the power supply switching section;
a zone control device that is connected to the slave control device to be capable of transmitting and receiving the communication frame and is configured to control an operation of the power supply switching section; and
a central control device that is connected to the zone control device to be capable of transmitting and receiving the communication frame, and
the management device is the communication system including the central control device and the zone control device.
